(19) United States
(12) Patent Application Publication
(10) Pub. No.: US 2005/0149370 A1
(43) Pub. Date: Jul. 7, 2005

(54) Project mapping

(76) Inventor: Kenneth Brown, Strasbourg (FR)

Correspondence Address: PERMAN & GREEN, 425 POST ROAD, FAIRFIELD, CT, 06824, US

(21) Appl. No.: 10/502,469

(22) PCT Filed: Jan. 25, 2002
(86) PCT No.: PCT/EP02/00765

(51) Int. Cl. G06F 17/60

(52) U.S. Cl. 705/8

(57) ABSTRACT

A system for visually mapping a project includes a plurality of tasks and a plurality of resources, each resource being available for handling, executing or otherwise processing one or more of the tasks. A relationship between a respective task and a respective resource is described by a respective relationship identifier. A processing unit receives data records of the plurality of tasks and resources together with the respective relationship identifiers, and represents the plurality of tasks in a first dimension of a matrix and the plurality of resources in a second dimension of the matrix. Each relationship identifier is represented at the interconnection or point of intersection between represented task and resource corresponding to that relationship identifier.

### BACKGROUND OF THE INVENTION

The present invention relates to project management generally referred to as coordinating different tasks to be done or processed by different resources such as persons, departments or functions.

### SUMMARY OF THE INVENTION

It is an object of the invention to provide tools or processes for improved project management. The object is solved by the independent claims. Preferred embodiments are shown by the dependent claims.

A project according to the present invention comprises a plurality of tasks and a plurality of resources available for handling, executing or otherwise processing one or more of the tasks. Each task and each resource is described by a data record comprising one or more characteristic features, properties, etc. thereof. A relationship identifier can be associated to each task representing its relationship to one or more of the resources. Accordingly or alternatively, a relationship identifier can be associated to each resource representing its relationship to one or more of the tasks.

Task can be e.g. manual activities, creative work, administrative work, technical testing, etc.

Resource can be e.g. an individual person, a group of persons (such as a department, a division, a project team, etc., a function within the company (such as a department head, a project manager, an external consultant, etc.), a competency (such as electrician, physicist, biologist, CAD-designer, etc.), or any other designation of functional units within a project, including non-human resources such as machines and material.

A relationship between task and resource can be e.g. an assignment (e.g. one resource is assigned to one task) or a non-assignment (e.g. one resource is NOT assigned to one task). In case of an assignment, the nature or kind of the assignment can be further specified e.g. by an assignment statement such as ‘responsible’ (i.e. this resource assigned to this task is also responsible for or the owner of this task) or ‘participant’ (i.e. this resource assigned to this task but with no specific responsibility, dominance or ownership for this task). In case of a non-assignment, the relationship identifier can e.g. be left open, omitted or ignored and only ‘positive’ assignments will be considered. In one embodiment, a non-assignment is regarded as default, so that only positive assignments have to be specified.

In a first embodiment of the invention, a processing unit receives the data records of the plurality of tasks and resources together with the respective relationship identifiers. For visually mapping the project, the processing unit then represents the plurality of tasks in a first dimension of a matrix and the plurality of resources in a second dimension of the matrix. Each relationship identifier is represented at the interconnection or point of intersection between each represented task and resource in the matrix, respectively. Thus, relationships between tasks and resources can be represented or illustrated efficiently allowing providing an improved project management.

In one embodiment, only such relationship identifiers will be represented for (positive) assignments between resource(s) and task(s). Preferably, the relationship identifiers for (positive) assignments are represented as dots or the like. For better visualization, all relationship identifiers relating to one task might further be connected by a line or similar connection. Each different type of relationship might also be represented by a different type of relationship identifier, e.g. different sizes of dots or different geometrical figures.

In another embodiment, the tasks are arranged in accordance to defined relationships between the tasks such as temporal relationships and/or priorities. Preferably, the tasks are arranged in temporal order so that tasks to be started earlier will be represented first in the matrix dimension. In other words, successive tasks will be represented in successive order along the first matrix dimension. This arrangement can significantly improve comprehensibility of the matrix.

In another embodiment, dependencies between tasks are further indicated in the matrix. Preferably, successive and dependent tasks are indicated e.g. by a pointer or an arrow pointing from one or more former tasks to the successive and dependent task(s). This indication of dependencies in particular in combination with an adequate arrangement of the tasks (preferably in successive order). In one embodiment, such dependencies are indicated using adequate pointers (preferably arrows), whereby the pointers are directed between dedicated or selected resources assigned to the respective tasks. Preferably, the pointers are directed between such resources assigned as being responsible or otherwise superior to the respective tasks.

In a further embodiment, a plurality of resources is grouped together and represented only as one resource group. If one member of the resource group has a certain relationship identifier with one task, the resource group represents that relationship identifier for that task. In case that the resource group has plural different relationship identifiers with one task, the resource group preferably represents only one relationship identifier for that task according to a predefined selection criteria. Selection criteria can be e.g. priority (preferably highest priority) or responsibility of an assignment (preferably highest responsibility). Preferably, resource groups are represented differently than other resources in order to clearly indicate the grouped nature. Adequate tools, might be provided for transforming plural resources into one resource group and vice versa.

Accordingly or alternatively, a plurality of tasks can be grouped together and represented only as one task group. If one member of the task group has a certain relationship identifier with one resource, the task group represents that relationship identifier for that resource. In case that the task group has plural different relationship identifiers with one resource, the task group preferably represents only one relationship identifier for that resource according to a predefined selection criteria. Selection criteria can be e.g. priority (preferably highest priority) or responsibility of an assignment (preferably highest responsibility). Preferably, task groups are represented differently than other tasks in order to clearly indicate the grouped nature. Adequate tools might be provided for transforming plural tasks into one task group and vice versa.

In a further preferred embodiment, the processing unit further analyses the matrix and provides a plausibility check. Potential failures detected by this plausibility check are preferably indicated directly in the matrix e.g. by modifying the current representation(s) associated with each potential failure. Such modification can be e.g. varying color or shape etc. In one embodiment wherein the tasks are arranged in temporal order and dependencies between tasks are indicated, dependencies directing in reverse temporal order (e.g. one task is dependent on results of another task, but the other task starts/ends later) can be candidates for potential failures. By arranging the tasks with increasing start date and indicating dependencies e.g. by arrows, arrows pointing ‘backwards’ in the sequence of successive tasks are likely to be potential failures.

Another plausibility check can be for detecting ‘isolated’ tasks i.e. tasks having no successive task being dependent thereon or tasks having no dependency to a precedent task. In an example when indicating dependencies e.g. by arrows, tasks without arrows or tasks either only receiving or ‘emitting’ an arrow can represent such ‘isolated’ tasks.

A further plausibility check can be for detecting ‘milestone-ignoring’ task dependencies, i.e. a dependency of a later task to a former task when a milestone is in-between. A milestone in that sense means a task, which constitutes a control point within the project and is typically attributed a defined date.

In a further embodiment, the processing unit provides an indication for which tasks are milestones. Preferably, a milestone would be visible by a readily visible border around the entire task, or by a gray or colored shading which accentuates this task in a visual manner.

In another embodiment, the processing unit further provides an indication for the state of one or more of the tasks. Different states can be e.g. ‘not started’, ‘pending’, ‘finished’, ‘cancelled’, ‘postponed’, ‘skipped’, ‘due’, ‘overdue’, ‘in-time’, ‘experiencing difficulties’, ‘running as foreseen’, ‘on schedule’, or ‘over time’. Preferably, different states are indicated in different colors, e.g. ‘green=in-time’, ‘yellow=experiencing difficulties’, ‘red=over time’.

In one embodiment, the tasks are represented by parallel lines in the first matrix dimension, and the resources are represented by parallel lines in the second matrix dimension. The first matrix dimension preferably is substantially perpendicular to the second matrix dimension.

In a further embodiment, two or more different but somehow related projects are provided in a joint representation, wherein preferably the first matrix dimensions of all projects are represented substantially parallel to each other and, accordingly, the second matrix dimensions of all projects are also represented substantially parallel to each other. In this case, one of the matrixes (preferably the one on the right hand side of the diagram) may be mirrored such that the matrixes appear back-to-back. Dependencies between tasks of different projects can be indicated in the joint matrix substantially in accordance with the above said. Preferably, such dependencies are indicated using adequate pointers (preferably arrows).

In yet another embodiment of the invention, the processing unit receives information about an actually provided visual mapping of the project, and the processing unit derives therefrom the data records of the plurality of tasks and resources together with the respective relationship identifiers. For that purpose, the processing unit analyses the representations of the plurality of tasks in the first dimension of the matrix and the plurality of resources in the second dimension of the matrix together with the representation of each relationship identifier at the interconnection between each represented task and resource in the matrix, respectively. This is in particular useful in case data records have been modified in the represented matrix, e.g. by user intervention or under influence of a different tool or software. However, even entirely new matrix representations (e.g. provided or designed by users) can thus be ‘transformed’ into machine-processable data records. It is clear that any additional information e.g. as introduced in the above embodiment, such as relationship types or dependencies, can thus be ‘transformed’ accordingly into the data records.

The invention can be partly or entirely embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIGS. 1A-D illustrate principles of the invention.

FIGS. 2A and B illustrate in detail a preferred embodiment of the invention.

### DETAILED DESCRIPTION OF THE INVENTION

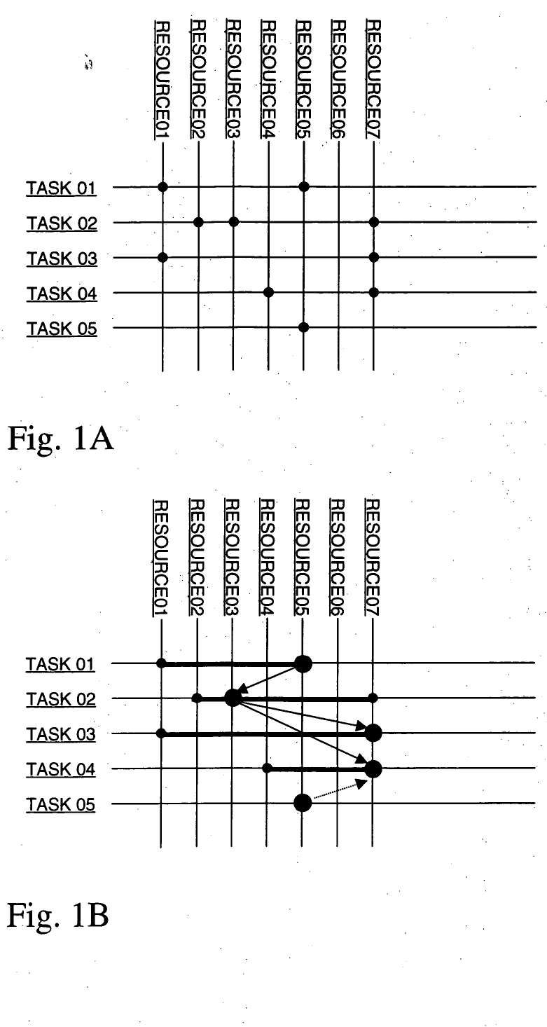

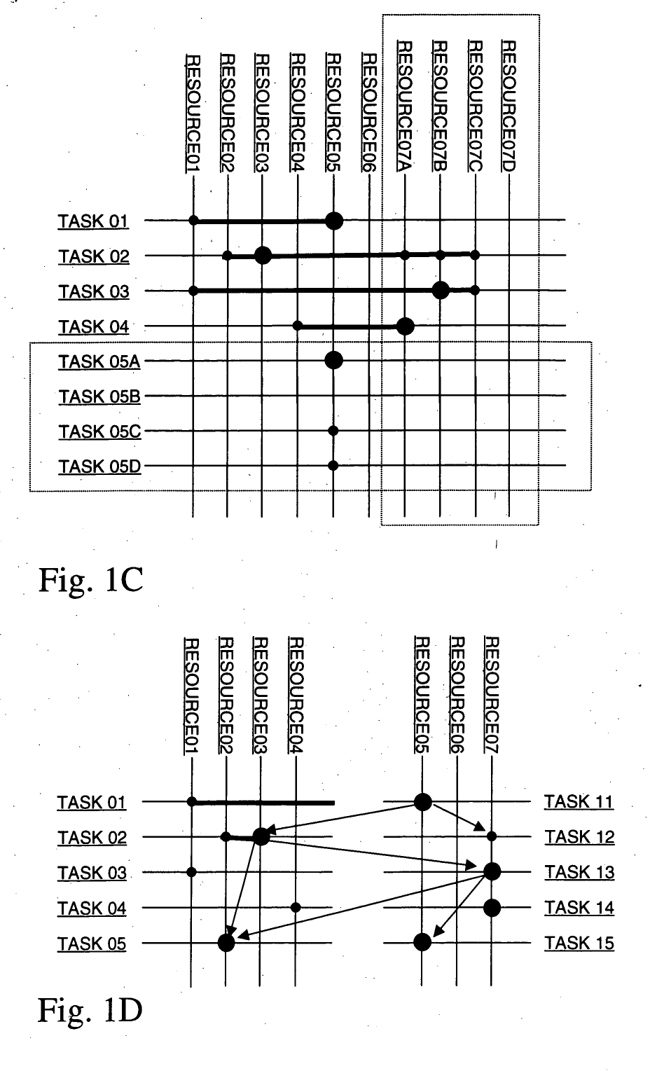

FIG. 1 illustrates the invention in an example of a project comprised of five tasks TASK01-TASK05 to be handled by seven resources RESOURCE01-RESOURCE07. Each task and each resource is described by a respective data record including relationship identifiers representing the assignments of resources to respective tasks.

A processing unit (not shown) receives the data records and represents the tasks TASK01-TASK05 in a first dimension of a matrix and the resources RESOURCE01-RESOURCE07 in a second dimension of the matrix. In the example of FIG. 1A, the first dimension is the x-axis of a 2-dimensional matrix and the second dimension is the y-axis thereof. Each relationship identifier is represented at the interconnection between task and resource in the matrix. In the example of FIG. 1A, a (positive) assignment of a resource to a respective task is represented by a dot, while a non-assignment (i.e. the resource is not assigned to this task) is considered as default and not further indicated.

In the example of FIG. 1A, task TASK01 is to be processed by assigned resources RESOURCE01 and RESOURCE05, task TASK02 is to be processed by assigned resources RESOURCE02, RESOURCE03, and RESOURCE07, etc.

FIG. 1B shows an alternative representation for the project example shown in FIG. 1A. First difference is that the type of assignment is further specified by indicating with a bigger dot the assignment of that resource responsible for that task and with a smaller dot the simple assignment of that resource to that task without having the responsibility thereof. Second difference is that all relationship identifiers relating to one task are connected by a thick line for better visualization.

Third difference is that dependencies between tasks are further indicated by arrows in the matrix. In the example of FIG. 1B, the execution of task TASK02 requires results from task TASK01. This is indicated by an arrow from resource RESOURCE05 assigned as responsible for task TASK01 to resource RESOURCE03 assigned as responsible for task TASK02. Accordingly, results from task TASK02 are to be reported to resource RESOURCE07 assigned as responsible for tasks TASK03 and TASK04. Eventually, results from task TASK05 are also to be reported to resource RESOURCE07 assigned as responsible for task TASK04.

In order to improve comprehensibility of the matrix, the tasks are arranged along the y-axis in successive order indicating that task TASK01 is to be started or processed before task TASK02, task TASK02 is to be started or processed before task TASK03, etc.

The processing unit might further analyze the matrix and provide a plausibility check for potential failures. In the example of FIG. 1B, it is detected that task TASK04 is dependent on results of task TASK05, but task TASK05 starts/ends later than task TASK04. Such arrow pointing ‘backwards’ is likely to be a potential failure and will therefore be indicated by a dotted or otherwise accentuated line. A user can then further analyze the dependency between tasks TASK04 and TASK05 and might correct that (e.g. that task TASK05 becomes dependent on results of task TASK04).

FIG. 1C illustrates an embodiment for the example of FIG. 1B, wherein resource RESOURCE07 represents a group of individual resources RESOURCE07A-RESOURCE07D, and task TASK05 represents a group of individual tasks TASK05A-TASK05D. While FIG. 1B shows the groups as such, the illustration of FIG. 1C depicts all individual tasks and resources of the groups.

FIG. 1D shows an example wherein two related projects are provided in a joint representation. Dependencies between tasks of the different projects are indicated by arrows.

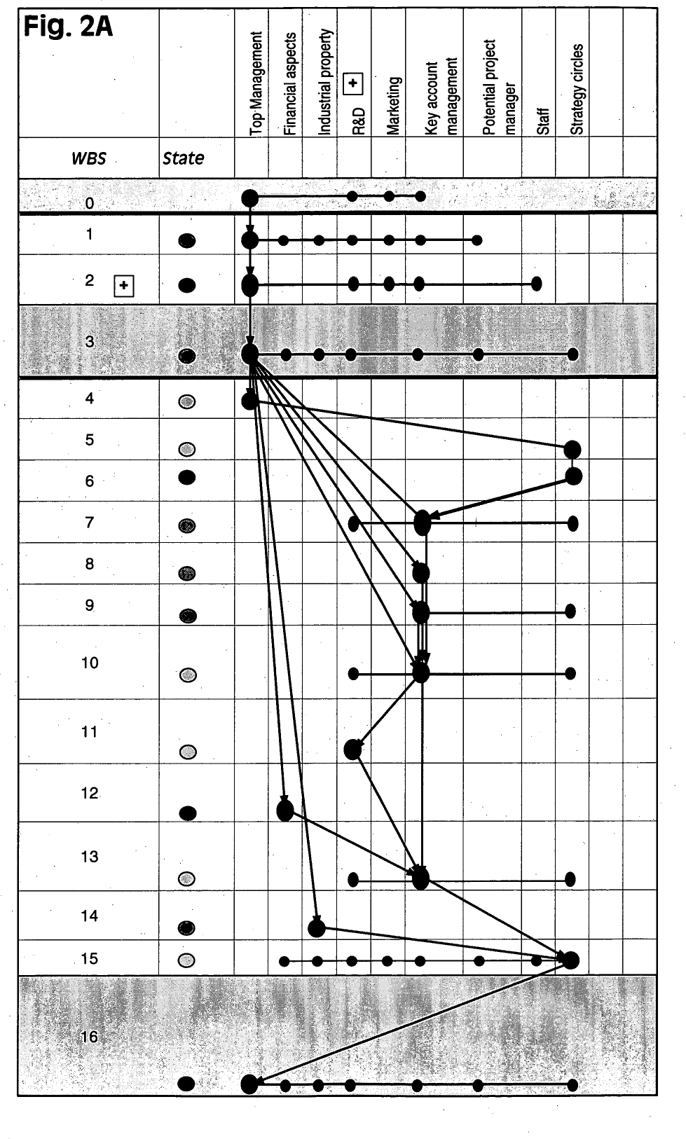

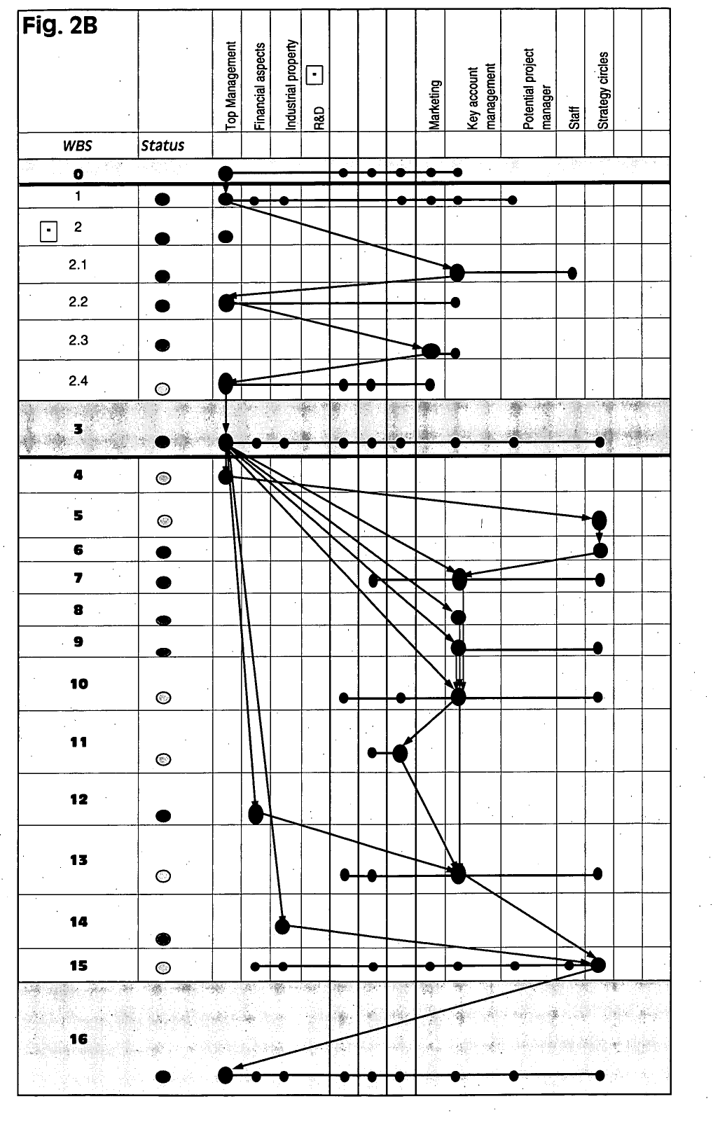

While FIGS. 1 illustrated basic examples, a more detailed example shall now be considered in conjunction with FIGS. 2A and 2B. The project mapping diagram presented here shall now be referred to as Matrix.

Data needed for the elaboration of the Matrix are preferably kept in a database or a file containing information concerning the project, as shown in Table 1 below. Examples are provided for data formats Microsoft Project (.mpp) and Primavera Project Planner for the Enterprise (P3e).

TABLE 1

| Data field in | | Examples for mapping | |
|---|---|---|---|
| database or file | Data Type | (.mpp and P3e) | Explanation |
| Unique identifier for | numerical | Unique ID | Unique task ID number |
| task | | task_ID | |
| WBS Code | Hierarchical | WBS or Outline_no. | Work Breakdown Structure |
| | numbering | wbs_id | Code |
| | (.mpp) or | | |
| | alphanumerical | | |
| | (P3e) | | |
| Task name | alphanumerical | Name (Task table) | Name of the task |
| | | task_name | |
| Status | alphanumerical | Status or other | Current status of task |
| | | status_code or other | |
| Predecessors | numerical | Unique ID Predecessors | List of all tasks of which |
| | | | the current task is |
| | | | dependent (has a |
| | | | predecessor-successor |
| | | | dependency relation). |
| | | | (Successor information is |
| | | | calculated out of |
| | | | predecessor information |
| | | | and therefore redundant) |
| Milestone | Boolean | Milestone | Task is a milestone if |
| | | task_type | value = 1 or task_type = milestone |
| Resource | alphanumerical | Resources | Person participating in |
| | | taskrsrc | task |
| Department | alphanumerical | Resource group | Department participating |
| | | OBS, resource codes | in task |
| Role | alphanumerical | User-defined fields | Competence of person in |
| | | role | the context of the project |
| Responsible | Responsible | First resource | Resource, department, or |
| | person | primary resource | role responsible for the |
| | | | elaboration of the task |

Using the data contained in the database or file, the representation according to the present invention can be generated as the Matrix of the project, as illustrated in FIGS. 2A-B. The Matrix lists the different tasks of the project from top to bottom, and with several alphanumeric fields (columns) on its left side.

Each of the data fields in Table 1 needed for the Matrix will now be described in detail. The first three fields are used to determine the text in the left-hand side of the Matrix (see FIGS. 2A-B) while the other six fields determine how the right hand side of the Matrix (see FIGS. 2A-B) will be drawn graphically.

Unique ID (Unique ID): The identification number ID is a number issued automatically during the planning of the project by the user. In the case of the Unique ID number, this number never changes, even when the task order is changed by the user. Therefore, Unique ID can be used as a key to keep track of tasks even when their order is changed. The Unique ID is preferably not displayed in the Matrix.

WBS-Code (WBS): The work breakdown structure (WBS) is a classic technique of project management with which the overall objective of a project is divided into several manageable tasks. The WBS-Code is a hierarchic code: a task with a number 2 (see FIGS. 2A), for instance, can have several subtasks 2.1, 2.2, 2.3, etc. (see FIG. 2B). Subtasks can be further divided into subtasks such as 2.1.1, 2.1.2, etc. The WBS-Code for a task is to be displayed in the first column of the Matrix (note that tasks and subtasks have a different length in their WBS-Code due to the hierarchic representation, but the unique ID-Number of any specific task will always be only one number. This number will remain unchanged when the task is made to a subtask or summary task or even when its order within the project is changed). The WBS-Code will be of further importance for the functionality of showing and hiding the subtasks of a summary task (see below).

Name (Name): The name of the task is the second column to be displayed on the left side of the Matrix. It simply specifies what is to be done in the task.

The Matrix therefore begins with two or more alphanumeric columns. Adjacent to these columns, columns representing the resources of the project are introduced, as are dots and arrows to illustrate the communication flow in the project. The following data fields determine the graphical representation of this right hand side of the Matrix.

Using the data contained in the database or file, many different types of Matrixes can be drawn by using resources, departments, roles, or any other attribute of the actors in the project to define the right hand side of the Matrix. Each actor of the project is represented by a column on the right hand side of the Matrix. The following explanations will concentrate on the first kind of Matrix using resources as column titles. All other Matrix types are elaborated in the same manner and will be described afterwards.

Once the columns have been defined, dots and arrows can be added to illustrate the assignments and dependencies in the project. The following fields provide the necessary information to do so.

Resources: All resources active in the task are marked by a dot.

Responsible: The responsible resource in each task is marked with a large black dot.

When there is more than one participating resource in a task, all participating and responsible resources may be connected with a black line.

Arrows are drawn between the responsible resource of a preceding task to the responsible of a subsequent task. The horizontal position of an arrow is thus determined by the information contained in each task. All arrows from preceding tasks are therefore to go to the large dot representing the responsible, and arrows going to succeeding tasks shall originate from this large dot (this is the case when the “Predecessors” fields of other tasks point to the current task).

Status: The user enters the current status of each task into this field. The processing unit of the system interprets the data of this field to display an intuitively comprehensible dot of a corresponding color, e.g. ‘green=in-time’, ‘yellow=experiencing difficulties’, ‘red=over time’.

Milestone (Milestone): This Boolean field is active when a task is a so-called milestone of a project. In this case, the task preferably appears in gray shading and with a border around it. Examples for milestones are Tasks 3 and 16 in FIGS. 2A-B. The text of the milestone preferably appears in bold print.

Summary tasks: Summary tasks regroup several subtasks to a larger task. This is important for a project manager in order to mask unnecessary detail, e.g. when he is trying to get an overview over a larger project. The notion of summary tasks and subtasks is closely related to that of WBS (work breakdown structure), with which a project is first broken down into larger tasks (sometimes called work sections) and then further into smaller tasks (see chapter on “WBS”).

In one embodiment, the user has the possibility to hide and show subtasks of a project, e.g. in order to view particular parts of a project in greater detail, while seeing only the summary tasks of parts which are of less importance. In this embodiment, summary tasks have a little box displayed next to their name so the user understands that these particular tasks contain subtasks. When the user clicks on one of these boxes with the “+” sign (see Task 2 in FIG. 2A), the sign changes to “−” and the subtasks are shown (see Task 2 in FIG. 2B). When the user clicks on one of the boxes to open a summary task and show its subtasks, the arrows and dots in the Matrix change. Any resource participating in one of the subtasks (responsible or not) now appears as a dot in the collapsed summary task, i.e. when the subtasks are hidden. In a further embodiment, a specific field is defined for the responsible resource of a summary task. Whichever resource is responsible for the summary task preferably appears as a large dot or whatever other graphical indicator may be found appropriate.

Since a summary task is in itself not an independent task but only an aggregation of several subtasks, the communication arrows preferably no longer go through the summary task when its subtasks are visible. However, direct communication arrows between summary tasks could exist if the user defined them explicitly. When communication arrows are defined directly with summary tasks, their communication arrows preferably still go out of the summary task even when subtasks become visible.

Since subtasks can be under the responsibility of several different resources, the responsible of each summary task needs to be defined separately. A summary task can even be under the responsibility of a resource that is not responsible for any of its subtasks, e.g. when a resource is responsible as a coordinator for the summary task. When the subtasks of a summary task are shown, the Responsible System Function of the summary task is preferably marked with a large circle or another graphical indicator found appropriate rather than a large dot to prevent misunderstandings.

When the user clicks on the box of a summary task to expand it, the communication arrows going to or originating from subtasks preferably no longer go to the summary task, but directly to the subtasks and their responsible functions.

The following tables Table 1 and Table 2 explain in detail the tasks of the FIGS. 2A and 2B, whereby Table 1 corresponds to FIG. 2A and Table 2 corresponds to FIG. 2B. The WBS-numbers link the respective tables and figures, so that e.g. the WBS-number 1 in FIG. 2A corresponds to the task “SWOT analysis” with the information “Strengths and weaknesses of the company” in Table 1.

TABLE 1

| WBS | Task | Information |
|---|---|---|
| 0 | MS 0: Kick-Off Decision | Go! |
| 1 | SWOT analysis | Strengths and weaknesses of the company |
| 2 | Definition of present business fields | List of business fields |
| | of the company | |
| 3 | MS 1: Which and how many | Which present and potential business fields |
| | business fields should the company | exist? Definition of future market strategy. |
| | pursue? | |
| 4 | Appointment of chairmen of each | Chairman of each strategy circle |
| | strategy circle | |
| 5 | Call for participation in strategy | Complete list of members for each strategy |
| | circles | circle |
| 6 | Strategy circle meetings | List of opportunities |
| 7 | Market identification for business | List of markets served and ignored |
| | field | |
| 8 | Analysis of refused offers | List of refused offers including reasons for |
| | | refusal. |
| 9 | Investigation of potential markets | List of potential markets in Spain and abroad |
| | within business field | |
| 10 | Analysis of competition | List of universities, institutes and companies |
| | | liable to serve similar customer needs |
| 11 | Identification of missing | List of missing competencies and resources |
| | competencies and resources w/ | and proposal for cooperation or other solutions |
| | regard to targeted markets and | |
| | customers | |
| 12 | Analysis of earnings potential | Information concering surplus creation, |
| | (profitability) by groups of customers | possible pricing policy. |
| 13 | New business opportunities | List of other business fields that have |
| | | appeared due to the in-depth investigation of |
| | | the market |
| 14 | Analysis of possibilities to protect | Industrial property protection suggestions |
| | knowledge in the business field | |
| 15 | Drafting of final report for business | Business field report |
| | field | |
| 16 | MS 2: Decision on future action | Are any important business fields not |
| | | covered? List of served, missed, potential |
| | | markets and refused offers. Analysis of |
| | | competition, missing competencies, |
| | | suggestion for cooperations. |

TABLE 2

| WBS | Task | Information |
|---|---|---|
| 0 | MS 0: Kick-Off Decision | Go! |
| 1 | SWOT analysis | Strengths and weaknesses |
| 2 | Definition of present business fields | List of business fields |
| | of the company | |
| 2.1 | Brainstorming event to identify new | New potential business fields |
| | business fields | |
| 2.2 | Delimitation of business fields | Exact definition of each business field |
| 2.3 | Definition of possible Marketing | Scenarios of different marketing strategies |
| | strategies | |
| 2.4 | Definition of terms of reference for | Terms of reference, goals and composition of |
| | “strategy circles” | SC's |
| 3 | MS 1: Which and how many | Which present and potential business fields |
| | business fields should the company | exist? Definition of future market strategy. |
| | pursue? | |
| 4 | Appointment of chairmen of each | Chairman of each strategy circle |
| | strategy circle | |
| 5 | Call for participation in strategy | Complete list of members for each strategy |
| | circles | circle |
| 6 | Strategy circle meetings | List of opportunities |
| 7 | Market identification for business | List of markets served and ignored |
| | field | |
| 8 | Analysis of refused offers | List of refused offers including reasons for |
| | | refusal. |
| 9 | Investigation of potential markets | List of potential markets in Spain and abroad |
| | within business field | |
| 10 | Analysis of competition | List of universities, institutes and companies |
| | | liable to serve similar customer needs |
| 11 | Identification of missing | List of missing competencies and resources |
| | competencies and resources w/ | and proposal for cooperation or other solutions |
| | regard to targeted markets and | |
| | customers | |
| 12 | Analysis of earnings potential | Information concering surplus creation, |
| | (profitability) by groups of customers | possible pricing policy. |
| 13 | New business opportunities | List of other business fields that have |
| | | appeared due to the in-depth investigation of |
| | | the market |
| 14 | Analysis of possibilities to protect | Industrial property protection suggestions |
| | knowledge in the business field | |
| 15 | Drafting of final report for business | Business field report |
| | field | |
| 16 | MS 2: Decision on future action | Are any important business fields not |
| | | covered? List of served, missed, potential |
| | | markets and refused offers. Analysis of |
| | | competition, missing competencies, |
| | | suggestion for cooperations. |

1. A system for visually mapping a project comprising a plurality of tasks (TASK01-TASK05) and a plurality of resources (RESOURCE01-RESOURCE07), each resource being available for handling, executing or otherwise processing one or more of the tasks, wherein a relationship between a respective task and a respective resource is described by a respective relationship identifier, the system comprising:
a processing unit adapted for receiving data records of the plurality of tasks and resources together with the respective relationship identifiers, and for representing the plurality of tasks in a first dimension of a matrix and the plurality of resources in a second dimension of the matrix, wherein each relationship identifier is represented at the interconnection or point of intersection between represented task and resource corresponding to that relationship identifier.

2. The system of claim 1, wherein each task and each resource is described by a data record comprising one or more characteristic features or properties thereof, and at least one of the relationship identifiers is associated a corresponding data record of the task or the resource.

3. The system of claim 1 or 2, wherein at least one of the resources is one of an individual person, a group of persons, a department, a function, a competency, or any other type of entity found appropriate to circumscribe an actor of the project.

4. The system according to claim 1 or any one of the above claims, wherein at least one of the relationships between task and resource is an assignment, so that the resource is assigned to the task, or a non-assignment, so that the resource is not assigned to the task.

5. The system according to claim 1 or any one of the above claims, wherein the processing unit is further adapted for specifying a type, nature or kind of the relationship.

6. The system according to claim 1 or any one of the above claims, wherein the processing unit is further adapted for representing each different type, nature or kind of the relationship by a different type of relationship identifier.

7. The system according to claim 1 or any one of the above claims, wherein the processing unit is further adapted for representing at least one of the relationship identifiers as a dot or similar geometrical figure.

8. The system according to claim 1 or any one of the above claims, wherein the processing unit is further adapted for representing all relationship identifiers relating to one task by a connected line or similar connection.

9. The system according to claim 1 or any one of the above claims, wherein the processing unit is further adapted for arranging the tasks in accordance to defined relationships between the tasks such as temporal relationships and/or priorities.

10. The system according to claim 1 or any one of the above claims, wherein the processing unit is further adapted for indicating dependencies between tasks.

11. The system according to claim 10, wherein the processing unit is further adapted for indicating dependencies between tasks by using pointers or arrows.

12. The system according to claim 1 or any one of the above claims, wherein the processing unit is further adapted for grouping a plurality of the resources together and representing those grouped resources as one resource group.

13. The system according to claim 1 or any one of the above claims, wherein the processing unit is further adapted for grouping a plurality of the tasks together and representing those grouped tasks as one task group.

14. The system according to claim 1 or any one of the above claims, wherein the processing unit is further adapted for analyzing the matrix and providing a plausibility check for detecting and/or indicating potential failures.

15. The system according to claim 1 or any one of the above claims, wherein the processing unit is further adapted for providing an indication for the state of one or more of the tasks.

16. The system according to claim 1 or any one of the above claims, wherein the processing unit is further adapted for representing the tasks by parallel lines in the first matrix dimension and the resources by parallel lines in the second matrix dimension.

17. The system according to claim 16, wherein the first matrix dimension is substantially perpendicular to the second matrix dimension.

18. The system according to claim 1 or any one of the above claims, wherein the processing unit is further adapted for providing two or more different projects in a joint representation, wherein the first and second matrix dimensions are each represented substantially parallel to each other.

19. A method for visually mapping a project comprising a plurality of tasks (TASK01-TASK05) and a plurality of resources (RESOURCE01-RESOURCE07), each resource being available for handling, executing or otherwise processing one or more of the tasks, wherein a relationship between a respective task and a respective resource is described by a respective relationship identifier, the method comprising the steps of:
receiving data records of the plurality of tasks and resources together with the respective relationship identifiers,
representing the plurality of tasks in a first dimension of a matrix,
representing the plurality of resources in a second dimension of the matrix, and
representing each relationship identifier at the interconnection or point of intersection between represented task and resource corresponding to that relationship identifier.

20. The method of claim 19, further comprising one or more of the following steps:
specifying a type, nature or kind of the relationship,
representing each different type, nature or kind of the relationship by a different type of relationship identifier,
representing at least one of the relationship identifiers as a dot or similar geometrical figure,
representing all relationship identifiers relating to one task by a connected line or similar connection,
arranging the tasks in accordance to defined relationships between the tasks such as temporal relationships and/or priorities,
indicating dependencies between tasks preferably using pointers or arrows,
grouping a plurality of the resources together and representing those grouped resources as one resource group,
grouping a plurality of the tasks together and representing those grouped tasks as one task group,
analyzing the matrix and providing a plausibility check for detecting and/or indicating potential failures,
providing an indication for the state of one or more of the tasks,
representing the tasks by parallel lines in the first matrix dimension and the resources by parallel lines in the second matrix dimension, wherein the first matrix dimension is preferably substantially perpendicular to the second matrix dimension,
providing two or more different projects in a joint representation, wherein the first and second matrix dimensions are each represented substantially parallel to each other.

21. A method comprising the steps of:
receiving information about a provided visual mapping of a project comprising a plurality of tasks (TASK01-TASK05) and a plurality of resources (RESOURCE01-RESOURCE07), each resource being available for handling, executing or otherwise processing one or more of the tasks, wherein a relationship between a respective task and a respective resource is described by a respective relationship identifier, wherein the plurality of tasks are represented in a first dimension of a matrix, the plurality of resources are represented in a second dimension of the matrix, and each relationship identifier are represented at the interconnection or point of intersection between represented task and resource corresponding to that relationship identifier, and
deriving from the received information data records of the plurality of tasks and resources together with the respective relationship identifiers.

22. The method of claim 21, further comprising the step of:
analyzing the representations of the plurality of tasks in the first dimension of the matrix and the plurality of resources in the second dimension of the matrix together with the representation of each relationship identifier at the interconnection between each represented task and resource in the matrix, respectively.

23. A software program or product, preferably stored on a data carrier, for executing the method of claim 6 or any one of the claims 7-23, when run on a data processing system such as a computer.
